(19) United States
(12) Patent Application Publication
(10) Pub. No.: US 2014/0277900 A1
(43) Pub. Date: Sep. 18, 2014

(54) MAPPING SEARCH ENGINE OFFERING SIDEWALK MAPS

(71) Applicant: Raj V. Abhyanker, Cupertino, CA (US)

(72) Inventor: Raj V. Abhyanker, Cupertino, CA (US)

(21) Appl. No.: 14/291,008

(22) Filed: May 30, 2014

Related U.S. Application Data
(63) Continuation-in-part of application No. 14/157,540, filed on Jan. 17, 2014.
Application No. 14/157,540 is a continuation-in-part of application No. 14/207,679, filed on Mar. 13, 2014.
Application No. 14/207,679 is a continuation-in-part of application No. 14/203,531, filed on Mar. 10, 2014, now Pat. No. 8,775,328.
Application No. 14/203,531 is a continuation of application No. 11/653,194, filed on Jan. 12, 2007.
Application No. 11/653,194 is a continuation-in-part of application No. 11/603,442, filed on Nov. 22, 2006, now abandoned.
(60) Provisional application No. 60/783,226, filed on Mar. 17, 2006.

(51) Int. Cl. G05D 1/02; G01C 21/32

(52) U.S. Cl. CPC G05D 1/021; G01C 21/32
USPC 701/25

(57) ABSTRACT

Disclosed are a method and a system of a mapping search engine offering sidewalk maps, according to one embodiment. In one embodiment, a method of a sidewalk mapping server includes calculating a slope angle of a sidewalk transitioning into a street in at least one of a start location and an end location of the sidewalk in a neighborhood area and determining a transition characteristic of the sidewalk transitioning into the street. The transition characteristic is at least one of a grade-down transition, a grade-up transition, and a gradual transition in at least one of the start location and the end location of the sidewalk in the neighborhood area. A sidewalk map of a neighborhood is generated based on a calculation of the slope angle of the sidewalk transitioning into the street and a determination of the transition characteristic of the sidewalk transitioning into the street.

### CLAIMS OF PRIORITY

This patent application claims priority from, and hereby incorporates by reference and claims priority from the entirety of the disclosures of the following cases and each of the cases on which they depend and further claim priority or incorporate by reference:

(1) U.S. Utility patent application Ser. No. 14/157,540 titled AUTONOMOUS NEIGHBORHOOD VEHICLE COMMERCE NETWORK AND COMMUNITY, filed Jan. 17, 2014.
(2) U.S. Utility patent application Ser. No. 14/207,679 titled PEER-TO-PEER NEIGHBORHOOD DELIVERY MULTI-COPTER AND METHOD, filed Mar. 13, 2014.
(3) U.S. Continuation patent application Ser. No. 14/203,531 titled ‘GEO-SPATIALLY CONSTRAINED PRIVATE NEIGHBORHOOD SOCIAL NETWORK’ filed Mar. 10, 2014, which is a continuation of U.S. patent application Ser. No. 11/653,194 titled ‘LODGING AND REAL PROPERTY IN A GEO-SPATIAL MAPPING ENVIRONMENT’ filed on Jan. 12, 2007, which further depends on U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006, U.S. Provisional patent application No. 60/817,470, titled ‘SEGMENTED SERVICES HAVING A GLOBAL STRUCTURE OF NETWORKED INDEPENDENT ENTITIES’, filed Jun. 28, 2006, U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006, U.S. Provisional patent application No. 60/854,230, titled ‘METHOD AND APPARATUS OF NEIGHBORHOOD EXPRESSION AND USER CONTRIBUTION SYSTEM’ filed on Oct. 25, 2006, and U.S. Utility patent application Ser. No. 11/603,442 titled ‘MAP BASED NEIGHBORHOOD SEARCH AND COMMUNITY CONTRIBUTION’ filed on Nov. 22, 2006.

### FIELD OF TECHNOLOGY

This disclosure relates generally to the technical fields of communications and, in one example embodiment, to a method, apparatus, and system of a mapping search engine offering sidewalk maps.

### BACKGROUND

Sidewalks may also be preferred method of travel. Alternate methods of transportation (e.g., bike lanes and/or roads) may not be suitable for people and/or autonomous. Traditional navigation methods and systems (e.g., Google Maps®) may not include information about sidewalks. This may prevent people and/or autonomous vehicles from reaching their destinations and/or may require several navigation means to be used in order to enable people and/or autonomous vehicles to complete their tasks.

### SUMMARY

A method, device and system of a mapping search engine offering sidewalk maps are disclosed. In one aspect, a method of a sidewalk mapping server includes calculating a slope angle of a sidewalk transitioning into a street in at least one of a start location and an end location of the sidewalk in a neighborhood area and determining a transition characteristic of the sidewalk transitioning into the street. The transition characteristic is at least one of a grade-down transition, a grade-up transition, and a gradual transition in at least one of the start location and the end location of the sidewalk in the neighborhood area. A sidewalk map of a neighborhood is generated based on a calculation of the slope angle of the sidewalk transitioning into the street and a determination of the transition characteristic of the sidewalk transitioning into the street.

The start location and/or the end location of the sidewalk may be determined in the neighborhood area. It may be sensed whether a yield sign, a stop sign, a street light, a pedestrian, a vehicle, and/or an obstruction exists when the sidewalk transitions to the street using a sensor. The sensor may be an ultrasound sensor, a radar sensor, a laser sensor, an optical sensor, and/or a mixed signal sensor. A first color of the sidewalk and/or a second color of the street may be optically determined. It may be sensed whether the pedestrian, the vehicle, and/or the obstruction exists in the sidewalk using the sensor.

Autonomous vehicles may be permitted to utilize the sidewalk map when planning autonomous routes through the neighborhood area. An initial sidewalk path may be created based on a sensing technology to detect obstacles in the neighborhood area. The neighborhood area may be in an urban neighborhood setting, a rural setting, and/or a suburban neighborhood setting. The initial sidewalk path may be refined to create an updated sidewalk path based on a feedback received from other autonomous vehicles traveling the initial sidewalk path encountering obstacles. The initial sidewalk path may be automatically updated based on the updated sidewalk path.

An estimated sidewalk time may be calculated from a starting location to an ending location of an autonomous vehicle requesting to traverse locations on the sidewalk map. A congestion between the starting location and/or the ending location may be determined based on the feedback received from autonomous vehicles traveling the initial path encountering delays. Encountered obstacles and/or encountered delays may be determined based on at least one sensor (e.g., the ultrasound sensor, a radio frequency sensor, the laser sensor, the radar sensor, the optical sensor, a stereo optical sensor, and/or a LIDAR sensor) of a traversing autonomous vehicle. The sidewalk map may be published through a computing device and/or a mobile device to a plurality of searching users of a map-sharing community. A user may be permitted to track the traversing autonomous vehicle while in route through a sidewalk map view of the computing device and/or the mobile device. The sidewalk map view may describe a visual representation of the first color of the sidewalk and/or a topology of the sidewalk.

In another aspect, a method of a sidewalk mapping server includes determining a start location and an end location of a sidewalk in a neighborhood area and determining a transition characteristic of the sidewalk transitioning into a street. The transition characteristic is at least one of a grade-down transition, a grade-up transition, and a gradual transition in at least one of the start location and the end location of the sidewalk in the neighborhood area. A sidewalk map may be generated of a neighborhood based on a slope angle of the sidewalk transitioning into the street and a determination of the transition characteristic of the sidewalk transitioning into the street. The slope angle of the sidewalk transitioning into the street in the start location and/or the end location of the sidewalk in the neighborhood area may be calculated.

In yet another aspect, a system includes a sidewalk mapping server configured to calculate a slope angle of a sidewalk transitioning into a street in at least one of a start location and an end location of the sidewalk in a neighborhood area, determine a transition characteristic of the sidewalk transitioning into the street (the transition characteristic is at least one of a grade-down transition, a grade-up transition, and a gradual transition in at least one of the start location and the end location of the sidewalk in the neighborhood area), and generate a sidewalk map of a neighborhood based on a calculation of the slope angle of the sidewalk transitioning into the street and a determination of the transition characteristic of the sidewalk transitioning into the street.

A location algorithm may determine the start location and the end location of the sidewalk in the neighborhood area. An transition obstruction algorithm may sense whether a yield sign, a stop sign, a street light, a pedestrian, a vehicle, and/or an obstruction exists when the sidewalk transitions to the street using a sensor. The sensor may be an ultrasound sensor, a radar sensor, a laser sensor, an optical sensor, and/or a mixed signal sensor.

A color algorithm may optically determine a first color of the sidewalk and/or a second color of the street. A sidewalk obstruction algorithm may sense whether the pedestrian, the vehicle, and/or the obstruction exists in the sidewalk using the sensor. A permission algorithm may permit autonomous vehicles to utilize the sidewalk map when planning autonomous routes through the neighborhood area.

A creation algorithm may create an initial sidewalk path based on a sensing technology to detect obstacles in the neighborhood area. The neighborhood area may be in an urban neighborhood setting, a rural setting, and/or a suburban neighborhood setting. A refining algorithm may refine the initial sidewalk path to create an updated sidewalk path based on a feedback received from other autonomous vehicles traveling the initial sidewalk path encountering obstacles. An update algorithm may automatically update the initial sidewalk path based on the updated sidewalk path.

An estimation algorithm may calculate an estimated sidewalk time from a starting location to an ending location of an autonomous vehicle requesting to traverse locations on the sidewalk map. A congestion algorithm may determine a congestion between the starting location and/or the ending location based on the feedback received from autonomous vehicles traveling an initial sidewalk path encountering delay. Encountered obstacles and/or encountered delays are determined based on at least one sensor (e.g., the ultrasound sensor, a radio frequency sensor, the laser sensor, the radar sensor, the optical sensor, a stereo optical sensor, and a LIDAR sensor) of a traversing autonomous vehicle. A publishing algorithm may publish the sidewalk map through a computing device and/or a mobile device to a plurality of searching users of a map-sharing community. A tracking algorithm may permit a user to track the traversing autonomous vehicle while in route through a sidewalk map view of the computing device and/or the mobile device. The sidewalk map view may describe a visual representation of the first color of the sidewalk and/or a topology of the sidewalk.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view showing a sidewalk data being communicated through a network to a sidewalk mapping server which generates a sidewalk map based on the sidewalk data and publishes the sidewalk map to a searching users in a map-sharing community, according to one embodiment.

FIG. 2 is an exploded view of the sidewalk mapping server of FIG. 1, according to one embodiment.

FIG. 3 is an update view of an initial sidewalk path being updated based on a feedback communicated from an autonomous vehicle to the sidewalk mapping server of FIG. 1, according to one embodiment.

FIG. 4 is a table view illustrating the relationship between data of a sidewalk path of FIG. 1, according to one embodiment.

FIG. 5 is a table view illustrating the sidewalk data of FIG. 1, according to one embodiment.

FIG. 6 is a sidewalk congestion and obstruction view of an autonomous vehicle traversing a sidewalk containing obstructions and congestions, according to one embodiment.

FIG. 7 is a user interface view of a mobile device of the user of FIG. 4 displaying a sidewalk map view, according to one embodiment.

FIG. 8 is a user interface view of a searching user selecting a sidewalk path using a computing device, according to one embodiment.

FIG. 9 is a critical path view illustrating a flow based on time in which critical operations of generating a sidewalk map and updating an initial sidewalk path, according to one embodiment.

FIG. 10 is a process flow of generating the sidewalk map of FIG. 9 based on a calculation of a slope angle and a determination of a transition characteristic, according to one embodiment.

Other features of the present embodiments will be apparent from the accompanying drawings and from the detailed description that follows.

### DETAILED DESCRIPTION

Disclosed are a method and system of a mapping search engine offering sidewalk maps, according to one embodiment.

FIG. 1 is a network view 150 showing a sidewalk data being communicated through a network to a sidewalk mapping server which generates a sidewalk map based on the sidewalk data and publishes the sidewalk map to a searching users in a map-sharing community, according to one embodiment. In particular, FIG. 1 shows the sidewalk mapping server 100, a network 101, a memory 102, a processor 104, a database 106, a sidewalk data 108, an autonomous vehicle 110A, an autonomous vehicle 110B, a sensor 112, a sidewalk 114, a start location 116, an end location 118, a slope angle 120, a street light 121, a street 122, a sidewalk map 124, a neighborhood area 126, a plurality of searching users 128, and a map-sharing community 130.

The sidewalk mapping server 100 may include the processor 104, the memory 102, and/or the database 106. The sidewalk mapping server 100 may be one or more server side data processing systems (e.g., web servers operating in concert with each other) that operate in a manner that provide a set of instructions to any number of client side devices (e.g., a mobile device 702 and/or a computing device 804) communicatively coupled with the sidewalk mapping server 100 through the network 101. For example, the sidewalk mapping server 100 may be a computing system (e.g., or a group of computing systems) that operates in a larger client-server database framework (e.g., such as in a social networking software such as Nextdoor.com, Fatdoor.com, Facebook.com, etc.).

FIG. 1 illustrates a number of operations between the sidewalk mapping server 100, the autonomous vehicle 110A, the autonomous vehicle 110B and the plurality of searching users 128. Particularly, circle ‘1’ of FIG. 1 illustrates the sidewalk data 108 being communicated from the autonomous vehicle 110A, through the network 101 (e.g., an Internet protocol network and/or a wide area network), to the sidewalk mapping server 100. The sidewalk data 108 may be comprised of, but is in no way limited to, the geo-spatial location of the autonomous vehicle 110 sending the sidewalk data 108, the geo-spatial location (e.g., coordinates) of the start location 116, the geo-spatial coordinates of the end location 118, sensor data (e.g., data generated by a sensory fusion algorithm of the autonomous vehicle 110) and/or, video, audio, and/or pictorial data. The sensor 112 may be an ultrasound sensor, a radar sensor, a laser sensor, an optical sensor, and a mixed signal sensor. The sensor 112 may comprise multiple sensors working in concert. The sidewalk data 108 may include any information used to calculate the slope angle 120 of the sidewalk 114 transitioning into the street 122, determining a transition characteristic 502 of the sidewalk 114, generate the sidewalk map 124 of the neighborhood area 126, and/or update an initial sidewalk path 302. The sidewalk data 108 may be attained from a data provider, city planning schematics, government material, and/or other means.

The autonomous vehicle 110 may be an aerial vehicle (e.g., a helicopter, a multi rotor copter (e.g., a quadcopter and/or an octocpoter), and/or a fixed wing aerial vehicle) and/or a land-based vehicle (e.g., a single wheel vehicle, a multi wheel vehicle, a rover vehicle, a car, an autonomous bicycle, an autonomous land-based robot). The sidewalk data 108 need not be gathered, generated, and/or communicated by an autonomous vehicle 110 and/or a sensor 112 of the autonomous vehicle 110.

In the embodiment of FIG. 1, the sidewalk mapping server 100 may use the sidewalk data 108 to generate the sidewalk map 124 based on the calculated slope angle 120 of the sidewalk 114 transitioning into the street 122 and/or the transition characteristics 502 determined using the sidewalk data 108. The sidewalk mapping server 100 may use existing sidewalk data 108 (e.g., received from autonomous vehicles 110, sensors 112, and/or input by users 402 and/or data sources) to generate the sidewalk map 124 and/or may incorporate sidewalk data 108 (e.g., new data) in real time as it is received.

Circle ‘2’ shows the sidewalk map 124 being published through the network 101 to the plurality of searching users 128 in the map-sharing community 130. The sidewalk map 124 may detail the start location 116, end location 118, slope angle 120, transition characteristics 502, color, length 510, obstruction 306s, congestion 408 patters etc. of any number of sidewalks 114 in at least one neighborhood area 126. The published sidewalk map 124 may be accessible to users 402 (e.g., searching users 802) in the map-sharing community 130 (e.g., Fatdoor.com). The sidewalk map 124 may be constantly updated, incorporating new sidewalk data 108. The sidewalk map 124 may enable the plurality of searching users 128 to request and/or generate sidewalk paths in the neighborhood area 126.

In one embodiment, the sidewalk map 124 may be generated by the sidewalk mapping server 100 using the processor 104, the memory 102, and/or the database 106. The sidewalk map 124 may be communicated continuously and/or updated. The sidewalk mapping server 100 may work in concert with the autonomous vehicle 110 (e.g., adapting the sidewalk map 124 to take into account information from the autonomous vehicle 110 (e.g., obstacles sensed, congestion 408 encountered, and/or new and/or additional data). A GPS network and/or a cellular network (not shown) may be communicatively couple with the sidewalk mapping server 100 and/or the autonomous vehicle 110. The GPS network and/or the cellular network may provide data and/or enable the autonomous vehicle 110 to operate and/or accurately generate and/or communicate the sidewalk data 108.

Circle ‘2’ further shows the sidewalk map 124 being communicated through the network 101 to the autonomous vehicle 110B. The sidewalk map 124 may be stored and/or updated in a memory 102 and/or database 106 of the autonomous vehicle 110B. In one embodiment, the autonomous vehicle 110 (e.g., the autonomous vehicle 110B) may not receive the sidewalk map 124 and/or may receive a sidewalk path (e.g., an initial sidewalk path 302) from the sidewalk mapping server 100. The sidewalk map 124 of FIG. 1 may represent an updated sidewalk map (e.g., a new updated map and/or a set of updated information added to an existing sidewalk map) generated based on the sidewalk data 108 communicated by autonomous vehicle 110A. The sidewalk data 108 may be a feedback 304 data (discussed in FIG. 3).

FIG. 2 is an exploded view 250 of the sidewalk mapping server 100 of FIG. 1, according to one embodiment. FIG. 2 shows a transition obstruction algorithm 202, a color algorithm 204, a sidewalk obstruction algorithm 206, a permission algorithm 208, a creation algorithm 210, a refining algorithm 212, an update algorithm 214, an estimation algorithm 216, a publishing algorithm 218, a tracking algorithm 220, a location algorithm 222, and a congestion algorithm 224. In one embodiment, the transaction obstruction algorithm 202 may sense whether at least one of a yield sign, a stop sign, a street light 121, a pedestrian 602, a vehicle, and/or an obstruction 306 exists when the sidewalk 114 transitions to the street 122. The transaction obstruction algorithm 202 may work in concert with the sensor 112 and/or the sensory fusion algorithm of the autonomous vehicle 110. In one embodiment, the transaction obstruction algorithm 202 may be configured to distinguish between permanent obstructions (e.g., benches, trash cans, traffic light pole, and/or trees) and non-permanent obstructions (e.g., people and/or moveable objects (e.g., objects that will likely not remain at a certain location)).

The location algorithm 222 may determine the start location 116 and/or the end location 118 of the sidewalk 114 in the neighborhood area 126. The start location 116 and/or end location 118 of the sidewalk 114 may be a set of geo-spatial coordinates (e.g., the point at which the sidewalk 114 turns into the street 122) and/or an area (e.g., multiple sets of geo-spatial coordinates). The area may be a transition area (e.g., from where the transition characteristic 502 begins to where it ends (e.g., the sidewalk 114 meets the street 122)). In one embodiment, sidewalks 114 may be categorized by direction and/or the street 122 they are on.

For example, if a sidewalk 114 runs North along Main street and, without breaking or transitioning to the street 122, branched around a corner and runs West, away from Main street along 1^{st} street, the sidewalk mapping server 100 may determine that a first sidewalk runs North along Main street and its ending location 406 is on the corner of Main and 1^{st} and a second sidewalk may be determined to run West along 1^{st} street. In one embodiment, the corner of 1^{st} and Main may not be the ending location 406 of the first sidewalk 114. The first sidewalk may continue to run North and the ending location 406 may be when Main street ends.

The color algorithm 204 may optically determine a first color of the sidewalk 412 and a second color of the street 414. The sidewalk data 108 may contain an image (e.g., a picture and/or a video) and/or the sensor 112 of the autonomous vehicle 110 may sense the color (e.g., a hue, a tone, a shade, a lightness, a darkness, a saturation, and/or a tint) of the sidewalk 114 and/or the street 122. A difference in color between the first color of the sidewalk 412 and the second color of the street 414 may be used to determine the boundaries of the sidewalk 114 (e.g., the start location 116, the end location 118, the width and/or the length 510). The color algorithm 204 may optically determine a surface texture of the sidewalk 114 and a surface texture of the street 122. The difference in texture between the street 122 and the sidewalk 114 may be used to determine the boundaries of the sidewalk 114.

The sidewalk obstruction algorithm 206 may determine if a pedestrian 602, a vehicle, and/or an obstruction 306 exists in the sidewalk 114. The sidewalk obstruction algorithm 206 may work in concert with the sensor 112 of the autonomous vehicle 110 and/or may use the sidewalk data 108 (e.g., data from the sensory fusion algorithm) to determine the identity of a sensed obstruction 306. In one embodiment, sidewalk obstruction algorithm 206 may be configured to distinguish between permanent obstructions (e.g., benches, trash cans, traffic light pole, and/or trees) and non-permanent obstructions (e.g., people and/or moveable objects (e.g., objects that will likely not remain at a certain location)). If the obstruction 306 is determined to be a permanent obstruction, the sensing entity (e.g., the autonomous vehicle 110) may communicate the sidewalk data 108 (e.g., a feedback data) to the sidewalk mapping server 100 and/or the sidewalk map 124 and/or sidewalk path may be updated.

The permission algorithm 208 may permit autonomous vehicles 110 to utilize the sidewalk map 124 when planning autonomous routes through the neighborhood area 126. The autonomous vehicle 110 and/or user 402 of the autonomous vehicle 110 (e.g., the owner, renter, or borrower of the autonomous vehicle 110 and/or at least one of the plurality of searching users 128) may be able to use the sidewalk map 124 (e.g., the sidewalk map 124 published to the plurality of searching users 128) to create sidewalk paths to enable the autonomous vehicle 110 to traverse sidewalks 114 in the neighborhood area 126. For example, the autonomous vehicle 110 may be able to access the sidewalk map 124 of a neighborhood area 126 when operating in the neighborhood area 126 and/or when the autonomous vehicle 110 is anticipated to operate in the neighborhood area 126 (e.g., has a scheduled delivery that may take the autonomous vehicle 110 through the neighborhood area 126 and/or is operating within a threshold proximity to the neighborhood area 126).

The creation algorithm 210 may create an initial sidewalk path 302 based on a sensing technology to detect obstacles in the neighborhood area 126 (e.g., an urban neighborhood setting, a rural setting, and a suburban neighborhood setting). The creation algorithm 210 may use the latest state of the sidewalk map 124 to create the initial sidewalk path 302 (e.g., the most efficient sidewalk path). The initial sidewalk path 302 may take into account congestion 408, distance 416, and/or obstacles previously sensed, obstacles currently being sensed, and/or data uploaded to the sidewalk mapping server 100.

The refining algorithm 212 may refine the initial sidewalk path 302 to create an updated sidewalk path 308 based on a feedback 304 received from other autonomous vehicles 110 traveling the initial sidewalk path 302 encountering obstacles. In one embodiment, the feedback 304 may be the sidewalk data 108. The refining algorithm 212 may incorporate sensed obstacles, congestion 408, and/or data communicated by autonomous vehicles 110 traveling along the initial sidewalk path 302 into the sidewalk map 124. The update algorithm 214 may automatically update (e.g., reroute and/or populate with additional information) the initial sidewalk path 302 based on the updated sidewalk path 308. This may enable the sidewalk mapping server 100 to provide up to date and/or optimal sidewalk paths and/or sidewalk maps 124 that have been refined with new information.

The estimation algorithm 216 may calculate an estimated sidewalk time 410 from the starting location 404 to the ending location 406 of the autonomous vehicle 110 requesting to traverse locations on the sidewalk map 124. The estimated sidewalk time 410 may be based on the sidewalk 114 distance 416 between the starting location 404 and the ending location 406, anticipated congestion 408 along the path, average times of traffic lights the path encounters, etc. The estimation algorithm 216 may calculate the estimated sidewalk time 410 from the starting location 404 to the ending location 406 of a searching user 802 (e.g., a pedestrian user).

The congestion algorithm 224 may determine a congestion 408 between the starting location 404 and the ending location 406 based on the feedback 304 received from autonomous vehicles 110 traveling an initial sidewalk path 302 encountering delays. The congestion algorithm 224 may work in concert with the estimation algorithm 216, the update algorithm 214, the refining algorithm 212, the creation algorithm 210, and/or the tracking algorithm 220. The publishing algorithm 218 may publish the sidewalk map 124 through a computing device 804 (e.g., a desktop computer and/or a portable computer) and a mobile device 702 (e.g., a smart phone, a tablet, and/or a mobile data processing system) to the plurality of searching users 128 of the map-sharing community 130. Users 402 (e.g., searching users 802) may be able to access and/or use the sidewalk map 124 of any neighborhood area 126.

The tracking algorithm 220 may permit a user 402 (e.g., one of the plurality of searching users 128 and/or a user 402 that commissioned (e.g., used, rented and/or borrowed) a traversing autonomous vehicle 110) to track the traversing autonomous vehicle 110 while in route through a sidewalk map view 704 of the computing device 804 and/or the mobile device 702. The sidewalk map view 704 may be a visual representation of the color and/or topology of the sidewalk 114. The sidewalk map view 704 may allow the user 402 to see the estimated sidewalk time 410, an estimated time of arrival, areas of congestion 408 (e.g., geo-spatial areas from where other autonomous vehicles 110 have reported congestion 408), and/or obstacles encountered by the traversing autonomous vehicle 110 and/or anticipated by the sidewalk mapping server 100.

FIG. 3 is an update view 350 of an initial sidewalk path being updated based on a feedback communicated from an autonomous vehicle to the sidewalk mapping server of FIG. 1, according to one embodiment. Particularly, FIG. 3 illustrates an initial sidewalk path 302, a feedback 304, an obstruction 306, and an updated sidewalk path 308. Circle ‘1’ shows the sidewalk mapping server 100 communicating the initial sidewalk path 302, through the network 101, to the autonomous vehicle 110. The initial sidewalk path 302 may be a route generated by the sidewalk mapping server 100 to guide the autonomous vehicle 110 along sidewalks 114 from the starting location 404 to the ending location 406 (shown in FIG. 4). The initial sidewalk path 302 may be a set of instructions (e.g., navigation data) that guides the autonomous vehicle 110. In the example embodiment of FIG. 3, the autonomous vehicle 110 senses the obstruction 306 (e.g., a large puddle, a pothole, and/or a box) along the initial sidewalk path 302.

In Circle ‘2,’ the autonomous vehicle 110 sends the feedback 304 to the sidewalk mapping server 100. The feedback 304 may be triggered when the autonomous vehicle 110 determines (e.g., using the sensory fusion algorithm) that the obstruction 306 represents a relevant change to the sidewalk map 124 and/or initial sidewalk path 302 (e.g., a permanent obstruction, a large obstruction 306 (e.g., one that blocks the sidewalk 114), and/or a dangerous obstruction 306 (e.g., one that may damage the autonomous vehicle 110 and/or pedestrians 602). In one embodiment, all data gathered by autonomous vehicles 110 operating in the neighborhood area 126 (e.g., sensor 112 data) may be sent to the sidewalk mapping server 100. The feedback 304 may be the sidewalk data 108 and/or may contain only new data (e.g., information not present in the database 106 and/or memory 102 of the sidewalk mapping server 100).

The sidewalk mapping server 100 may use the feedback 304 to update the sidewalk map 124 of the neighborhood community (e.g., enabling the plurality of searching users 128 to learn of dangerous obstructions in their neighborhood area 126 and/or lean of changes to the sidewalk 114 between the start location 116 and the end location 118) and/or the initial sidewalk map 124. In Circle ‘3,’ the updated sidewalk path 308 is sent from the sidewalk mapping server 100 to the autonomous vehicle 110. The updated sidewalk path 308 may be a new sidewalk path and/or the initial sidewalk path 302 with additional information added. The updated sidewalk path 308 may instruct the autonomous vehicle 110 to continue along the initial sidewalk path 302 (e.g., in the case that the obstruction 306 does not hinder the autonomous vehicle 110's ability to continue along a particular sidewalk 114). In one embodiment, the updated sidewalk path 308 may route the autonomous vehicle 110 along a new path (e.g., in the case that the obstruction 306 and/or congestion 408 renders the initial sidewalk path 302 suboptimal and/or impassable). The autonomous vehicle 110 may not be required to wait for the updated sidewalk path 308. The autonomous vehicle 110 may be able to traverse the obstruction 306 on its own and/or continue along the initial sidewalk path 302. The updated sidewalk path 308 may be communicated to other autonomous vehicles 110 that are and/or will be traversing the initial sidewalk path 302.

In one embodiment, autonomous vehicles 110 operating in the neighborhood area 126 may be able to communicate with each other through ad-hoc local networks. These peer to peer communications may enable autonomous vehicles 110 to update sidewalk paths on their own based on feedback 304 from other autonomous vehicles 110. These peer-to-peer communications may enable autonomous vehicles 110 to operate and/or update sidewalk maps 124 and/or sidewalk paths in areas with poor or non-existent internet availability. In one embodiment, the sidewalk map 124 may be stored in the autonomous vehicles 110. The autonomous vehicles 110 may be able to apply feedback 304 to the sidewalk map 124 and/or update sidewalk paths internally and/or communicate changes and/or updates to the sidewalk mapping server 100 at regular intervals and/or certain times (e.g., when an obstacle is sensed that is deemed worthy of updating and/or when the autonomous vehicle 110 regains central communication to the sidewalk mapping server 100). In one embodiment, minor obstructions (e.g., non-permanent obstacles) and/or minor congestion 408 may be communicated via the ad hoc local network to other autonomous vehicles 110 but not the sidewalk mapping server 100.

FIG. 4 is a table view 450 illustrating the relationship between data of a sidewalk path of FIG. 1, according to one embodiment. FIG. 4 shows a user 402, a starting location 404, an ending location 406, a congestion 408, an estimated sidewalk time 410, a first color of the sidewalk 412, a second color of the street 414, and a distance 416. The table of FIG. 4 may be a table of the database 106 of the sidewalk mapping server 100 (shown in FIG. 1).

The user 402 may be at least one of the plurality of searching users 128, a user of the sidewalk mapping server 100, and/or an autonomous vehicle 110 for whom the sidewalk path is generated. The starting location 404 may be the point from where the sidewalk path will begin (e.g., an address, a set of geo-spatial coordinates, and/or a place name). The user 402 may be able to save locations (e.g., “Home” may be linked to their verified residential address on the network 101 (e.g., Fatdoor.com, Nextdoor.com, and/or the map-sharing community 130) and/or designate preferred routes (e.g., preferred sidewalks 114, preferences for back roads over main roads, and/or desire to avoid street lights 121). The ending location 406 may be the destination and/or the point to which the sidewalk path leads.

The congestion 408 may be foot traffic and/or delays caused by pedestrians 602 and/or autonomous vehicles 110. The congestion 408 may be signified in the table of FIG. 4 by a “yes” or a “no” and/or by an amount (e.g., heavy, light, 5 minute delay etc.). The congestion 408 may be a current determined congestion 408 (e.g., determined using the feedback 304 of autonomous vehicles 110 and/or users 402) and/or an expected congestion 408 (e.g., based on past patterns and/or projected patters). The congestion 408 may be an overall congestion 408 across the sidewalk path (e.g., an overall delay of 5 minutes due to congestion 408) and/or a location specific congestion 408 (e.g., certain places along the sidewalk path may be determined to have congestion 408 and/or the user 402 may be updated about these certain places).

The estimated sidewalk time 410 may be a determined amount of time it will take to traverse the sidewalk path from the starting location 404 to the ending location 406. The estimated sidewalk time 410 may take into account average travel speeds (e.g., of the average pedestrian 602 and/or autonomous vehicle 110), congestion 408, obstructions 306, street lights 121, and/or the distance 416. The first color of the sidewalk 412 may be sensed by the sensor 112 on the autonomous vehicle 110 and/or determined using other means of data collection. The first color of the sidewalk 412 may be used to differentiate between the sidewalk 114 and the street 122 and/or the sidewalk 114 and another sidewalk. The second color of the street 414 may be sensed through the same means and/or similar means as the first color of the sidewalk 412. In one embodiment, the texture and/or other physical characteristics of the sidewalk 114 and/or street 122 may be determined and/or used to generate the sidewalk map 124 and/or sidewalk path.

The distance 416 may be the sidewalk distance between the starting location 404 and ending location 406. In one embodiment, the table may include a set of directions and/or a list of sidewalks 114 the user 402 will traverse along the sidewalk path. The slope angle 120 may be shown for each transition characteristic 502.

FIG. 5 is a table view 550 illustrating the sidewalk data of FIG. 1, according to one embodiment. FIG. 5 shows a transition characteristic 502, a grade-up transition 504, a grade-down transition 506, a gradual transition 508, and a length 510. The table of FIG. 5 may be a table of the sidewalk mapping server 100 and/or may be stored in the database 106.

The transition characteristics 502 may be the grade-up transition 504, the grade-down transition 506 and/or the slope angle 120. The table may include the number of transitions characteristics of a particular sidewalk 114 and/or the location(s) of the transition characteristics 502. The gradual transition 508 may include a start and/or an end point of the transition (e.g., the geo-spatial location at which the slope angle 120 begins and/or ends (e.g., the point at which the sidewalk 114 meets the street 122)).

The length 510 may be the total length 510 of the sidewalk 114 (e.g., from the start location 116 to the end location 118). In one embodiment, sidewalks 114 may have multiple start and/or end locations 118. The length 510 may be the total length of the sum of all part of the sidewalk 114. The length 510 may include information about the lengths 510 of separate sections of the sidewalk 114 (e.g., sections categorized by directional heading (e.g., North-South) and/or sections categorized by the street 122 that they are adjacent to). The sidewalk data 108 may include additional data not shown in FIG. 5. For example, the sidewalk data 108 may include obstruction 306s, congestion 408 (e.g., congestion 408 patterns), the first color of the sidewalk 412, the second color of the street 414 (e.g., the street 122 adjacent to the sidewalk 114 and/or a particular section of the sidewalk 114), the name and/or location of the sidewalk 114 (e.g., categorized by the direction and/or street 122 the sidewalk 114 runs along).

FIG. 6 is a sidewalk congestion and obstruction view 650 of an autonomous vehicle traversing a sidewalk containing obstructions and congestion, according to one embodiment. The autonomous vehicle 110 may travel on the sidewalk 114 along the sidewalk path. The autonomous vehicle 110 may sense pedestrians 602 (e.g., the pedestrian 602) and/or may treat them as obstacles. The autonomous vehicle 110 may determine that the pedestrian 602 is a moving object and may determine the pedestrian's 602 trajectory and/or navigate around the pedestrian 602. The autonomous vehicle 110 may not communicate the detection of a pedestrian 602 (e.g., a single pedestrian 602 and/or a group of pedestrians 602 that do not constitute congestion 408) to the sidewalk mapping server 100. In one embodiment, the autonomous vehicle 110 may determine that it has encountered congestion 408 when the sensor 112 of the autonomous vehicle 110 detects a threshold number and/or concentration of moving objects (e.g., pedestrians 602), when the autonomous vehicle 110 has traveled below a certain speed for a threshold amount of time due to moving obstacles, and/or when a distance 416 traveled by the autonomous vehicle 110 in relation to time has reached a threshold level.

The autonomous vehicle 110 may detect the obstruction 306 on the sidewalk 114. In one embodiment, the autonomous vehicle 110 may determine (e.g., using the sensory fusion algorithm) that the obstruction 306 is not permanent (e.g., a box left momentarily by a shopper) and/or may not communicate the obstruction 306 as feedback 304 to the sidewalk mapping server 100. The autonomous vehicle 110 may be able to navigate around the obstruction 306 and/or continue along the initial sidewalk path 302. In the example embodiment of FIG. 6, the street light 121 may be a new addition to the neighborhood area 126 and/or may not have been present when sidewalk data 108 about the sidewalk 114 was gathered. Upon sensing the street light 121, the autonomous vehicle 110 may send data as the feedback 304 to the sidewalk mapping server 100 so that the sidewalk map 124 and/or sidewalk path may be updated. In one embodiment, the sidewalk map 124 and/or sidewalk path (e.g., the initial sidewalk path 302) may be stored on the autonomous vehicle 110. The autonomous vehicle 110 may be able to determine that the street light 121 represents new data and/or may communicate the sensing of the street light 121 (e.g., the location of the street light 121, the sidewalk 114 the street light 121 was sensed on, the sidewalk path the street light 121 was sensed on, and/or the sensed nature (e.g., size, shape, and/or color) of the street light 121) to the sidewalk mapping server 100.

FIG. 7 is a user interface view 750 of a mobile device of the user of FIG. 4 displaying a sidewalk map view, according to one embodiment. In particular, FIG. 7 shows a mobile device 702, and a sidewalk map view 704. The user 402 (e.g., the searching user 802) may be able to access the map-sharing community 130 (e.g., Fatdoor.com) using the mobile device 702. The mobile device 702 (e.g., a smartphone, a tablet, and/or a portable data processing system) may access the map-sharing community 130 through the network 101 using a browser application of the mobile device 702 (e.g., Google®, Chrome) and/or through a client-side application downloaded to the mobile device 702 (e.g., a Nextdoor.com mobile application, a Fatdoor.com mobile application) operated by the user 402. In an alternate embodiment, a computing device (e.g., the computing device 804 of FIG. 8, a non-mobile computing device 804, a laptop computer, and/or a desktop computer) may access the map-sharing community 130 through the network 101.

The user 402 may be able to receive and/or view updates about the autonomous vehicle 110 traversing the sidewalk path. The user 402 may be able to view if obstructions 306 have been encountered, what the obstructions 306 are, where they were encountered, and/or view pictures and/or video captured by the autonomous vehicle 110. The user 402 may able to view if congestion 408 was encountered, where it was encountered, and/or the nature of the congestion 408. In one embodiment, the user 402 may be informed if the autonomous vehicle 110 receives the updated sidewalk path 308. The user 402 may only be notified of the updated sidewalk path 308 if the autonomous vehicle 110 must alter its original path (e.g., the updated sidewalk path 308 is substantially different from the initial sidewalk path 302 (e.g., if the estimated sidewalk time 410 has changed and/or if the distance 416 has changed). The estimated sidewalk time 410 may be an estimated total time it will take to travel the sidewalk path. The estimated sidewalk time 410 may be the time left to reach the ending location 406 (e.g., time until destination) and/or the time that has elapsed since leaving the starting location 404.

The sidewalk map view 704 may show a satellite map, a geometric map, a ground-level view, an aerial view, a three-dimensional view, and/or another type of map view. The sidewalk map view 704 may enable the user 402 to track the autonomous vehicle 110 as it traverses the sidewalk path. In one embodiment, the user 402 may be able to view a video captured by a camera of the autonomous vehicle 110. The user 402 may be able to switch between the camera view and the sidewalk map view 704. In one embodiment, the sidewalk map view 704 may enable the user 402 to see areas of congestion 408, obstructions 306, and/or other autonomous vehicles 110 operating in the neighborhood area 126.

FIG. 8 is a user interface view 850 of a searching user selecting a sidewalk path using a computing device, according to one embodiment. Particularly, FIG. 8 shows a searching user 802, a computing device 804, a selected sidewalk path 806, and a high congestion area 808. In one embodiment, searching users 802 of the map-sharing community 130 may be able to generate sidewalk paths to take them to destinations in the neighborhood area 126. The searching user 802 may be presented with multiple options (e.g., multiple initial sidewalk paths 302) from which to choose. The user 402 may be able to view the multiple sidewalk paths on the sidewalk map view 704. The searching user 802 may be able to view listed directions which detail where the searching user 802 must turn and/or how long the searching user 802 should continue along a particular sidewalk 114.

The searching user 802 may be able to see high congestion areas 808 along the sidewalk path(s), obstructions 306 (e.g., obstructions 306 detected and/or communicated as feedback 304 by autonomous vehicles 110)), and/or be able to track their own progress along the sidewalk path using the sidewalk map view 704 on their mobile device 702. The searching user 802 may be able to filter results based on the distance 416 of the sidewalk path, the estimated sidewalk time 410, a preference for certain street etc.

FIG. 9 is a critical path view 950 illustrating a flow based on time in which critical operations of generating a sidewalk map and updating an initial sidewalk path, according to one embodiment. In operation 902, a sidewalk mapping server 100 generates a sidewalk map 124 of a neighborhood area 126 based on a calculation of a slope angle 120 of a sidewalk 114 transitioning into a street 122 and a determination of a transition characteristic 502. The sidewalk map 124 is then published to a plurality of users 402 in a map-sharing community 130 in operation 904. The plurality of users 402 may be able to view the sidewalk map 124 and/or generate sidewalk paths to direct themselves and/or autonomous vehicles 110 in the neighborhood area 126.

In operation 906, the sidewalk mapping server 100 generates an initial sidewalk path 302. The initial sidewalk path 302 may be generated upon a request of at least one of the plurality of searching users 128 and/or an autonomous vehicle 110. In operation 908, an autonomous vehicle 110 detects an obstacle (e.g., a permanent obstruction) in the neighborhood area 126 (e.g., along the initial sidewalk path 302) using a sensing technology (e.g., the sensor 112) and sends feedback 304 (e.g., the feedback 304) to the sidewalk mapping server 100. In one embodiment, the autonomous vehicle 110 may only communicate feedback 304 about permanent obstructions, congestion 408 above a threshold level, and/or obstacles that hinder the autonomous vehicle 110's ability to continue along the initial sidewalk path 302.

The sidewalk mapping server 100 refines the initial sidewalk path 302 to create an updated sidewalk path 308 based on the feedback 304 in operation 910. The autonomous vehicle 110 receives the updated sidewalk path 308 from the sidewalk mapping server 100 in operation 912. In one embodiment, the sidewalk mapping server 100 may update the sidewalk map 124 of the neighborhood area 126 based on the feedback 304. An updated sidewalk map 124 may be published to the plurality of searching users 128 in the map-sharing community 130.

FIG. 10 is a process flow 1050 of generating the sidewalk map 124 of FIG. 9 based on a calculation of a slope angle 120 and a determination of a transition characteristic 502, according to one embodiment. Particularly, operation 1002 may calculate a slope angle 120 of a sidewalk 114 transitioning into a street 122 in at least one of a start location 116 and an end location 118 of the sidewalk 114 in a neighborhood area 126. A transition characteristic 502 of the sidewalk 114 transitioning into the street 122 may be determined in operation 1004. The transition characteristic 502 may be a grade-up transition 504, a grade-down transition 506, and/or a gradual transition 508 in the start location 116 and/or the end location 118 of the sidewalk 114 in the neighborhood area 126. Operation 1006 may generate a sidewalk map 124 of a neighborhood based on a calculation of the slope angle 120 of the sidewalk 114 transitioning into the street 122 and a determination of the transition characteristic 502 of the sidewalk 114 transitioning into the street 122.

Disclosed are a method and system of a mapping search engine offering sidewalk maps, according to one embodiment. In one embodiment, a method of a sidewalk mapping server 100 includes calculating a slope angle 120 of a sidewalk 114 transitioning into a street 122 in at least one of a start location 116 and an end location 118 of the sidewalk 114 in a neighborhood area 126 and determining a transition characteristic 502 of the sidewalk 114 transitioning into the street 122. The transition characteristic 502 is at least one of a grade-down transition 506, a grade-up transition 504, and a gradual transition 508 in at least one of the start location 116 and the end location 118 of the sidewalk 114 in the neighborhood area 126. A sidewalk map 124 of a neighborhood is generated based on a calculation of the slope angle 120 of the sidewalk 114 transitioning into the street 122 and a determination of the transition characteristic 502 of the sidewalk 114 transitioning into the street 122.

The start location 116 and/or the end location 118 of the sidewalk 114 may be determined in the neighborhood area 126. It may be sensed whether a yield sign, a stop sign, a street light 121, a pedestrian 602, a vehicle, and/or an obstruction 306 exists when the sidewalk 114 transitions to the street 122 using a sensor 112. The sensor 112 may be an ultrasound sensor, a radar sensor, a laser sensor, an optical sensor, and/or a mixed signal sensor. A first color of the sidewalk 412 and/or a second color of the street 414 may be optically determined. It may be sensed whether the pedestrian 602, the vehicle, and/or the obstruction 306 exists in the sidewalk 114 using the sensor 112.

Autonomous vehicles 110 may be permitted to utilize the sidewalk map 124 when planning autonomous routes through the neighborhood area 126. An initial sidewalk path 302 may be created based on a sensing technology to detect obstacles in the neighborhood area 126. The neighborhood area 126 may be in an urban neighborhood setting, a rural setting, and/or a suburban neighborhood setting. The initial sidewalk path 302 may be refined to create an updated sidewalk path 308 based on a feedback 304 received from other autonomous vehicles 110 traveling the initial sidewalk path 302 encountering obstacles. The initial sidewalk path 302 may be automatically updated based on the updated sidewalk path 308.

An estimated sidewalk time 410 may be calculated from a starting location 404 to an ending location 406 of an autonomous vehicle 110 requesting to traverse locations on the sidewalk map 124. A congestion 408 between the starting location 404 and/or the ending location 406 may be determine based on the feedback 304 received from autonomous vehicles 110 traveling the initial path encountering delays. Encountered obstacles and/or encountered delays may be determined based on at least one sensor 112 (e.g., the ultrasound sensor, a radio frequency sensor, the laser sensor, the radar sensor, the optical sensor, a stereo optical sensor, and/or a LIDAR sensor) of a traversing autonomous vehicle. The sidewalk map 124 may be published through a computing device 804 and/or a mobile device 702 to the plurality of searching users 128 of a map-sharing community 130. A user 402 may be permitted to track the traversing autonomous vehicle 110 while in route through a sidewalk map view 704 of the computing device 804 and/or the mobile device 702. The sidewalk map view 704 may describe a visual representation of the first color of the sidewalk 412 and/or a topology of the sidewalk 114.

In another embodiment, a method of a sidewalk mapping server 100 includes determining a start location 116 and an end location 118 of a sidewalk 114 in a neighborhood area 126 and determining a transition characteristic 502 of the sidewalk 114 transitioning into a street 122. The transition characteristic 502 is at least one of a grade-down transition 506, a grade-up transition 504, and a gradual transition 508 in at least one of the start location 116 and the end location 118 of the sidewalk 114 in the neighborhood area 126. A sidewalk map 124 may be generated of a neighborhood based on a slope angle 120 of the sidewalk 114 transitioning into the street 122 and a determination of the transition characteristic 502 of the sidewalk 114 transitioning into the street 122. The slope angle 120 of the sidewalk 114 transitioning into the street 122 in the start location 116 and/or the end location 118 of the sidewalk 114 in the neighborhood area 126 may be calculated.

In yet another embodiment, a system includes a sidewalk mapping server 100 configured to calculate a slope angle 120 of a sidewalk 114 transitioning into a street 122 in at least one of a start location 116 and an end location 118 of the sidewalk 114 in a neighborhood area 126, determine a transition characteristic 502 of the sidewalk 114 transitioning into the street 122 (the transition characteristic 502 is at least one of a grade-down transition 506, a grade-up transition 504, and a gradual transition 508 in at least one of the start location 116 and the end location 118 of the sidewalk 114 in the neighborhood area 126), and generate a sidewalk map 124 of a neighborhood based on a calculation of the slope angle 120 of the sidewalk 114 transitioning into the street 122 and a determination of the transition characteristic 502 of the sidewalk 114 transitioning into the street 122.

A location algorithm may determine the start location 116 and the end location 118 of the sidewalk 114 in the neighborhood area 126. An transition obstruction 306 algorithm may sense whether a yield sign, a stop sign, a street light 121, a pedestrian 602, a vehicle, and/or an obstruction 306 exists when the sidewalk 114 transitions to the street 122 using a sensor 112. The sensor 112 may be an ultrasound sensor 112, a radar sensor 112, a laser sensor 112, an optical sensor 112, and/or a mixed signal sensor 112.

A color algorithm may optically determine a first color of the sidewalk 412 and/or a second color of the street 414. A sidewalk obstruction algorithm may sense whether the pedestrian 602, the vehicle, and/or the obstruction 306 exists in the sidewalk 114 using the sensor 112. A permission algorithm may permit autonomous vehicles 110 to utilize the sidewalk map 124 when planning autonomous routes through the neighborhood area 126.

A creation algorithm may create an initial sidewalk path 302 based on a sensing technology to detect obstacles in the neighborhood area 126. The neighborhood area 126 may be in an urban neighborhood setting, a rural setting, and/or a suburban neighborhood setting. A refining algorithm may refine the initial sidewalk path 302 to create an updated sidewalk path 308 based on a feedback 304 received from other autonomous vehicles 110 traveling the initial sidewalk path 302 encountering obstacles. An update algorithm may automatically update the initial sidewalk path 302 based on the updated sidewalk path 308.

An estimation algorithm may calculate an estimated sidewalk time 410 from a starting location 404 to an ending location 406 of an autonomous vehicle 110 requesting to traverse locations on the sidewalk map 124. A congestion algorithm may determine a congestion 408 between the starting location 404 and/or the ending location 406 based on the feedback 304 received from autonomous vehicles 110 traveling an initial sidewalk path 302 encountering delay. Encountered obstacles and/or encountered delays are determined based on at least one sensor 112 (e.g., the ultrasound sensor, a radio frequency sensor, the laser sensor, the radar sensor, the optical sensor, a stereo optical sensor, and a LIDAR sensor) of a traversing autonomous vehicle 110. A publishing algorithm may publish the sidewalk map 124 through a computing device 804 and/or a mobile device 702 to the plurality of searching users 128 of a map-sharing community 130. A tracking algorithm may permit a user 402 to track the traversing autonomous vehicle 110 while in route through a sidewalk map view 704 of the computing device 804 and/or the mobile device 702. The sidewalk map view 704 may describe a visual representation of the first color of the sidewalk 412 and/or a topology of the sidewalk 114.

An example embodiment will now be described. In one example embodiment, autonomous vehicles 110 may be ideal for making deliveries in a neighborhood environment. However, local residents and/or government may prohibit autonomous vehicles form operating in streets and/or bike lanes. This may limit applications of autonomous vehicles as there may be no efficient and/or reliable way for autonomous vehicles to navigate neighborhood areas 126 without using streets 122. The autonomous vehicles may be allowed on sidewalks 114 but may have difficulty navigating the sidewalks without a map and/or set of directions. This may lead to inefficiencies (e.g., new routes being created for every journey) and/or prevention of autonomous vehicles reaching their destination(s).

Neighbors in the neighborhood area may join the map-sharing community. They may be able to view and/or contribute to sidewalk maps of their neighborhood area. In one embodiment, autonomous vehicles may be able to access the sidewalk maps and/or sidewalk paths. Autonomous vehicles may be directed to locations in the neighborhood area 126 and/or may be able to travel entirely on sidewalks 114 using the most efficient and/or up-to-date route possible.

In another example embodiment, Sarah may own a neighborhood deli. She may have a faithful clientele base in her neighborhood. However, Sarah may find that many of her faithful customers have stopped coming into the shop as their schedules have become busy. Sarah may not have the financial means and/or resources to implement a delivery service. As a result, Sarah's deli may suffer.

Sarah may see an autonomous vehicle 110 operating in her neighborhood. She may learn about the map-sharing community and/or join. Sarah's bakery may be on a busy street 122. Delivery drivers and/or vehicles may not be able to readily access the street due to traffic. Deliveries made on streets may be slow and/or unreliable.

Sarah may be able to use autonomous vehicles to make deliveries in her neighborhood using sidewalks. Sarah may be able to save her bakery and/or expand her clientele. By joining the map-sharing community 130, Sarah may be able to reliably and/or affordably deliver goods to individuals in her neighborhood.

In yet another example embodiment, Tom may have just moved into a neighborhood. It may be beautiful day and/or Tom may wish to walk to his friend's house. Tom may not know the best route to take and/or may not know which streets have sidewalks and/or will not make him walk in the street. Tom may also be unaware of the fastest walking path, as he may not know of a cut-through near his house that may allow a pedestrian to reach his friend's address in half the time.

Tom may log onto his profile on the map-sharing community and/or enter his starting location (e.g., his home address) and his ending location (e.g., his friend's address). Tom may be able to decide which route he wishes to take (e.g., the fastest route, the route with the shortest distance, and/or a route that does not take him on a certain street). Tom may be able to see that there is significant congestion along the route with the shortest distance (as a school may have just let out for the day). Tom may decide to take the cut through which offered the shortest estimated sidewalk time. Tom may be able to safely and/or quickly walk through the unfamiliar neighborhood to his friend's house and enjoy the beautiful weather.

Although the present embodiments have been described with reference to specific example embodiments, it will be evident that various modifications and changes may be made to these embodiments without departing from the broader spirit and scope of the various embodiments. For example, the various devices, algorithms, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor 104 DSP circuitry).

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a sidewalk mapping server comprising:
calculating a slope angle of a sidewalk transitioning into a street in at least one of a start location and an end location of the sidewalk in a neighborhood area;
determining a transition characteristic of the sidewalk transitioning into the street, wherein the transition characteristic is at least one of a grade-down transition, a grade-up transition, and a gradual transition in at least one of the start location and the end location of the sidewalk in the neighborhood area; and
generating a sidewalk map of a neighborhood based on a calculation of the slope angle of the sidewalk transitioning into the street and a determination of the transition characteristic of the sidewalk transitioning into the street.

2. The method of claim 1 further comprising:
determining the start location and the end location of the sidewalk in the neighborhood area; and
sensing whether at least one of a yield sign, a stop sign, a street light, a pedestrian, a vehicle, and an obstruction exists when the sidewalk transitions to the street using a sensor,
wherein the sensor is at least one of an ultrasound sensor, a radar sensor, a laser sensor, an optical sensor, and a mixed signal sensor.

3. The method of claim 2 further comprising:
optically determining a first color of the sidewalk and a second color of the street; and
sensing whether at least one of the pedestrian, the vehicle, and the obstruction exists in the sidewalk using the sensor.

4. The method of claim 3 further comprising:
permitting autonomous vehicles to utilize the sidewalk map when planning autonomous routes through the neighborhood area; and
creating an initial sidewalk path based on a sensing technology to detect obstacles in the neighborhood area, wherein the neighborhood area is in at least one of an urban neighborhood setting, a rural setting, and a suburban neighborhood setting.

5. The method of claim 4 further comprising:
refining the initial sidewalk path to create an updated sidewalk path based on a feedback received from other autonomous vehicles traveling the initial sidewalk path encountering obstacles; and
automatically updating the initial sidewalk path based on the updated sidewalk path.

6. The method of claim 5 further comprising:
calculating an estimated sidewalk time from a starting location to an ending location of an autonomous vehicle requesting to traverse locations on the sidewalk map; and
determining a congestion between the starting location and the ending location based on the feedback received from autonomous vehicles traveling the initial path encountering delays,
wherein encountered obstacles and encountered delays are determined based on at least one sensor of a traversing autonomous vehicle, comprising any of the ultrasound sensor, a radio frequency sensor, the laser sensor, the radar sensor, the optical sensor, a stereo optical sensor, and a LIDAR sensor.

7. The method of claim 6 further comprising:
publishing the sidewalk map through at least one of a computing device and a mobile device to a plurality of searching users of a map-sharing community; and
permitting a user to track the traversing autonomous vehicle while in route through a sidewalk map view of at least one of the computing device and the mobile device, wherein the sidewalk map view describe a visual representation of at least one of the first color of the sidewalk and a topology of the sidewalk.

8. A method of a sidewalk mapping server comprising:
determining a start location and an end location of a sidewalk in a neighborhood area;
determining a transition characteristic of the sidewalk transitioning into a street, wherein the transition characteristic is at least one of a grade-down transition, a grade-up transition, and a gradual transition in at least one of the start location and the end location of the sidewalk in the neighborhood area; and
generating a sidewalk map of a neighborhood based on a slope angle of the sidewalk transitioning into the street and a determination of the transition characteristic of the sidewalk transitioning into the street.

9. The method of claim 8 further comprising:
calculating the slope angle of the sidewalk transitioning into the street in at least one of the start location and the end location of the sidewalk in the neighborhood area;
sensing whether at least one of a yield sign, a stop sign, a street light, a pedestrian, a vehicle, and an obstruction exists when the sidewalk transitions to the street using a sensor,
wherein the sensor is at least one of an ultrasound sensor, a radar sensor, a laser sensor, an optical sensor, and a mixed signal sensor.

10. The method of claim 9 further comprising:
optically determining a first color of the sidewalk and a second color of the street; and
sensing whether at least one of the pedestrian, the vehicle, and the obstruction exists in the sidewalk using the sensor.

11. The method of claim 10 further comprising:
permitting autonomous vehicles to utilize the sidewalk map when planning autonomous routes through the neighborhood area; and
creating an initial sidewalk path based on a sensing technology to detect obstacles in the neighborhood area, wherein the neighborhood area is in at least one of an urban neighborhood setting, a rural setting, and a suburban neighborhood setting.

12. The method of claim 11 further comprising:
refining the initial sidewalk path to create an updated sidewalk path based on a feedback received from other autonomous vehicles traveling the initial sidewalk path encountering obstacles; and
automatically updating the initial sidewalk path based on the updated sidewalk path.

13. The method of claim 12 further comprising:
calculating an estimated sidewalk time from a starting location to an ending location of an autonomous vehicle requesting to traverse locations on the sidewalk map; and
determining a congestion between the starting location and the ending location based on the feedback received from autonomous vehicles traveling the initial sidewalk path encountering delays,
wherein encountered obstacles and encountered delays are determined based on at least one sensor of a traversing autonomous vehicle, comprising any of the ultrasound sensor, a radio frequency sensor, the laser sensor, the radar sensor, the optical sensor, a stereo optical sensor, and a LIDAR sensor.

14. The method of claim 13 further comprising:
publishing the sidewalk map through at least one of a computing device and a mobile device to a plurality of searching users of a map-sharing community; and
permitting a user to track the traversing autonomous vehicle while in route through a sidewalk map view of at least one of the computing device and the mobile device, wherein the sidewalk map view describe a visual representation of at least one of the first color of the sidewalk and a topology of the sidewalk.

15. A system comprising:
a sidewalk mapping server to:
calculate a slope angle of a sidewalk transitioning into a street in at least one of a start location and an end location of the sidewalk in a neighborhood area;
determine a transition characteristic of the sidewalk transitioning into the street, wherein the transition characteristic is at least one of a grade-down transition, a grade-up transition, and a gradual transition in at least one of the start location and the end location of the sidewalk in the neighborhood area; and
generate a sidewalk map of a neighborhood based on a calculation of the slope angle of the sidewalk transitioning into the street and a determination of the transition characteristic of the sidewalk transitioning into the street.

16. The system of claim 15 further comprising:
a location algorithm to determine the start location and the end location of the sidewalk in the neighborhood area; and
an transition obstruction algorithm to sense whether at least one of a yield sign, a stop sign, a street light, a pedestrian, a vehicle, and an obstruction exists when the sidewalk transitions to the street using a sensor,
wherein the sensor is at least one of an ultrasound sensor, a radar sensor, a laser sensor, an optical sensor, and a mixed signal sensor.

17. The system of claim 16 further comprising:
a color algorithm to optically determine a first color of the sidewalk and a second color of the street;
a sidewalk obstruction algorithm to sense whether at least one of the pedestrian, the vehicle, and the obstruction exists in the sidewalk using the sensor;
a permission algorithm to permit autonomous vehicles to utilize the sidewalk map when planning autonomous routes through the neighborhood area; and
a creation algorithm to create an initial sidewalk path based on a sensing technology to detect obstacles in the neighborhood area, wherein the neighborhood area is in at least one of an urban neighborhood setting, a rural setting, and a suburban neighborhood setting.

18. The system of claim 17 further comprising:
a refining algorithm to refine the initial sidewalk path to create an updated sidewalk path based on a feedback received from other autonomous vehicles traveling the initial sidewalk path encountering obstacles; and
an update algorithm to automatically update the initial sidewalk path based on the updated sidewalk path.

19. The system of claim 18 further comprising:
an estimation algorithm to calculate an estimated sidewalk time from a starting location to an ending location of an autonomous vehicle requesting to traverse locations on the sidewalk map; and
a congestion algorithm to determine a congestion between the starting location and the ending location based on the feedback received from autonomous vehicles traveling the initial sidewalk path encountering delays,
wherein encountered obstacles and encountered delays are determined based on at least one sensor of a traversing autonomous vehicle, comprising any of the ultrasound sensor, a radio frequency sensor, the laser sensor, the radar sensor, the optical sensor, a stereo optical sensor, and a LIDAR sensor.

20. The system of claim 19 further comprising:
a publishing algorithm to publish the sidewalk map through at least one of a computing device and a mobile device to a plurality of searching users of a map-sharing community; and
a tracking algorithm to permit a user to track the traversing autonomous vehicle while in route through a sidewalk map view of at least one of the computing device and the mobile device, wherein the sidewalk map view describe a visual representation of at least one of the first color of the sidewalk and a topology of the sidewalk.
